(19) United States
(12) Patent Application Publication
(10) Pub. No.: US 2022/0172688 A1
(43) Pub. Date: Jun. 2, 2022

(54) DISPLAY METHOD, COMPUTER STORAGE MEDIUM AND DISPLAY DEVICE

(71) Applicants: Fuzhou BOE Optoelectronics Technology Co., Ltd., Fujian (CN); BOE Technology Group Co., Ltd., Beijing (CN)

(72) Inventors: Jinfeng CHEN, Beijing (CN); Nani LIU, Beijing (CN); Yifeng SU, Beijing (CN); Xiaoli KONG, Beijing (CN); Qibiao LIN, Beijing (CN); Xuening ZHAO, Beijing (CN); Weiming YU, Beijing (CN); Wenjian YAO, Beijing (CN)

(21) Appl. No.: 17/487,373

(22) Filed: Sep. 28, 2021

(30) Foreign Application Priority Data
Nov. 27, 2020 (CN) 202011359078.4

(51) Int. Cl. G09G 3/36; G06K 9/00

(52) U.S. Cl. CPC G09G 3/3611; G06K 9/00604; G09G 2320/048; G09G 2354/00; G09G 2360/14; G09G 2320/0257

(57) ABSTRACT

The present disclosure provides a display method, a computer storage medium, and a display device. The display method includes: detecting a frame image including a still image; accumulating a retention time of the still image in the frame image, the retention time is a time for uninterruptedly displaying the still image; determining whether the accumulated retention time is greater than a threshold value; sequentially shifting data of the frame image by n rows in response to that the accumulated retention time is greater than the threshold value, the threshold value is an accumulated value of the retention time when a line afterimage begins to appear on the still image; a row direction of the n rows is a scanning direction of the frame image; wherein 1≤n≤3N/4, N is a total number of rows scanned for one frame image, n is an integer, and 3N/4 is rounded to an integer.

### CROSS-REFERENCE TO RELATED APPLICATIONS

The present disclosure claims the priority of Chinese Patent Application No. 202011359078.4, filed on Nov. 27, 2020, the contents of which are incorporated herein by reference in its entirety.

### TECHNICAL FIELD

The present disclosure relates to the field of display technology, and in particular, to a display method, a computer storage medium and a display device.

### BACKGROUND

A common electrode and a data signal line of a liquid crystal display product (LCD) are overlapped with each other, so as to form an overlap capacitor. When a voltage of the data signal line changes, a voltage of the common electrode is distorted due to the coupling and then deviates from a predetermined value. If the deviation cannot be recovered to a predetermined potential before the scanning on one row of pixels is finished, a difference between an actual pixel voltage and a common voltage is not the predetermined value. If the actual voltages of the pixels of positive and negative frames are asymmetric with respect to the voltage of the common electrode, the voltage of the common electrode deviates from the predetermined value to accumulate a DC component. After the afterimage is switched to a gray-scale image, the pixel voltage at a boundary changes due to the residual direct current (DC) component, so that the transmittance at the boundary changes, and a line afterimage is formed, as shown in FIG. 1.

At present, the line afterimage is generally improved by reducing the distortion of the voltage of the common electrode, for example, decreasing the signal voltage, changing the inversion manner for driving, increasing the inversion frequency of the driving signal, reducing dielectric constant of media, reducing coupling capacitance, increasing the compensation input points for the common electrode, and the like. However, in the production of large-sized or oversized screen, the conventional countermeasures cannot improve the line afterimage very well because of the limitation such as equipment, materials and cost. For example, in a medium-size or small-size product, the line afterimage can be adjusted to be substantially invisible by adding or adjusting the compensation points for the far, middle or near common electrode, namely, the line afterimage is substantially eliminated; and in the large-sized or oversized product, the line afterimage is still visible to human eyes, that is, the line afterimage is not completely eliminated.

### SUMMARY

As an aspect, a display method is provided. The method includes: detecting a frame image including a still image; accumulating a retention time of the still image in the frame image, wherein the retention time is a time for uninterruptedly displaying the still image; determining whether the accumulated retention time is greater than a threshold value; sequentially shifting data of the frame image by n rows in response to that the accumulated retention time is greater than the threshold value, the threshold value is an accumulated value of the retention time when a line afterimage begins to appear on the still image; a row direction of the n rows of data is a scanning direction of the frame image; wherein 1≤n≤3N/4, is a total number of rows scanned for one frame image, n is an integer, and 3N/4 is rounded to an integer.

In an embodiment, data of the frame image is sequentially shifted by n rows along an input direction of the data of the frame image or a direction opposite to the input direction of the data of the frame image.

In an embodiment, the display method further includes: inserting n rows of data for displaying a black image into the frame image, wherein the frame image with the n rows of data for displaying the black image inserted and the n rows of data sequentially shifted is an anti-afterimage frame image, and the frame image without the n rows of data for displaying the black image inserted and without the n rows of data sequentially shifted is an original frame image.

In an embodiment, the display method further includes: inserting the n rows of data for displaying the black image into first n rows of the frame image, sequentially shifting the data of the frame image by n rows along the input direction of the data of the frame image, and displaying no data in the last n rows of the frame image, so as to obtain a first anti-afterimage frame image; and alternately displaying the first anti-afterimage frame image and the original frame image.

In an embodiment, the display method further includes: inserting the n rows of data for displaying the black image into the last n rows of the frame image, sequentially shifting the data of the frame image by n rows along the direction opposite to the input direction of the data of the frame image, and displaying no data in first n rows of the frame image, so as to obtain a second anti-afterimage frame image; and alternately displaying the second anti-afterimage frame image and the original frame image.

In an embodiment, the display method further includes: inserting the n rows of data for displaying the black image into first n rows of the frame image, sequentially shifting the data of the frame image by n rows along the input direction of the data of the frame image, and displaying no data in last n rows of the frame image, so as to obtain a first anti-afterimage frame image; inserting the n rows of data for displaying the black image into last n rows of the frame image, sequentially shifting the data of the frame image by n rows along the direction opposite to the input direction of the data of the frame image, and displaying no data in first n rows of the frame image, so as to obtain a second anti-afterimage frame image; and sequentially displaying the original frame image, the first anti-afterimage frame image, the original frame image, and the second anti-afterimage frame image.

In an embodiment, each of a display time of the anti-afterimage frame image and a display time of the original frame image is equal to the threshold value.

In an embodiment, a display time of the original frame image is the threshold value, a display time of the anti-afterimage frame image is an elimination time of the line afterimage appeared when the accumulated retention time of the still image reaches the threshold value, and the elimination time of the line afterimage is less than the threshold value.

In an embodiment, the display method further includes: monitoring whether a person is watching a screen displaying the frame image; wherein performing a switch between the anti-afterimage frame image and the original frame image in response to that nobody is watching the screen displaying the frame image, and performing no switch between the anti-afterimage frame image and the original frame image in response to that a person is watching the screen displaying the frame image.

In an embodiment, the method includes monitoring whether a person is watching the screen displaying the frame image through an infrared detection device or a human eye grabbing device.

In an embodiment, n is in a range from 1 to 10.

As another aspect, a computer storage medium having computer program instructions stored thereon is provided, when executed by a processor, implement the above display method.

As yet another aspect, a display device includes the above computer storage medium.

### BRIEF DESCRIPTION OF THE DRAWINGS

FIG. 1 is a schematic diagram showing a line afterimage formed when a liquid crystal display product displays a still image;

FIG. 2 is a flow chart showing a display method according to an embodiment of the present disclosure;

FIG. 3 is a schematic diagram showing a frame image obtained after data for displaying the black image is inserted into the frame image and n rows of data of the frame image is sequentially shifted according to an embodiment of the present disclosure;

FIG. 4 is a schematic diagram showing that an original frame image and an anti-afterimage frame image (a frame image with eliminated afterimage) are displayed alternately according to an embodiment of the present disclosure;

FIG. 5 is a schematic diagram showing a frame image obtained after data for displaying the black image is inserted into the frame image and n rows of data of the frame image is sequentially shifted according to an embodiment of the present disclosure:

FIG. 6 is a schematic diagram showing that an original frame image and an anti-afterimage frame image are displayed alternately according to an embodiment of the present disclosure;

FIG. 7 is a schematic diagram showing that an original frame image and an anti-afterimage frame image are displayed alternately according to an embodiment of the present disclosure.

### DETAILED DESCRIPTION

In order to enable one of ordinary skill in the art to better understand the technical solution of the present disclosure, a display method, computer storage medium and display device of the present disclosure are further described in detail below in combination with the accompanying drawings and specific embodiments.

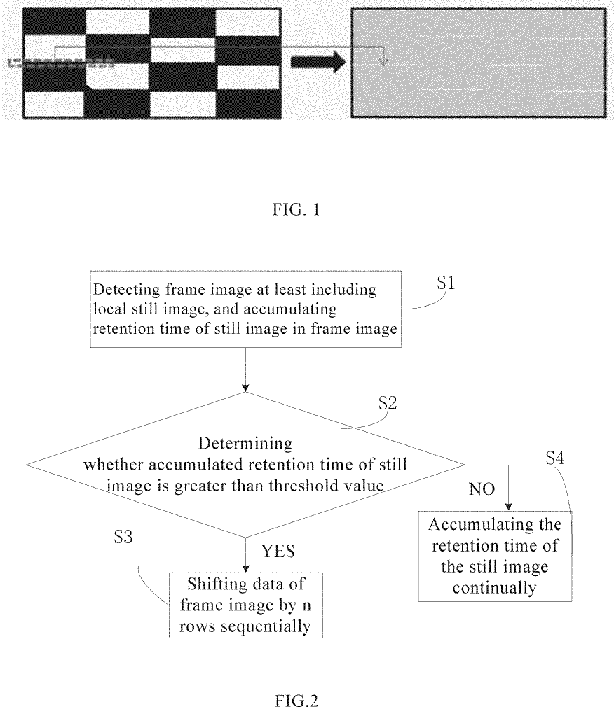

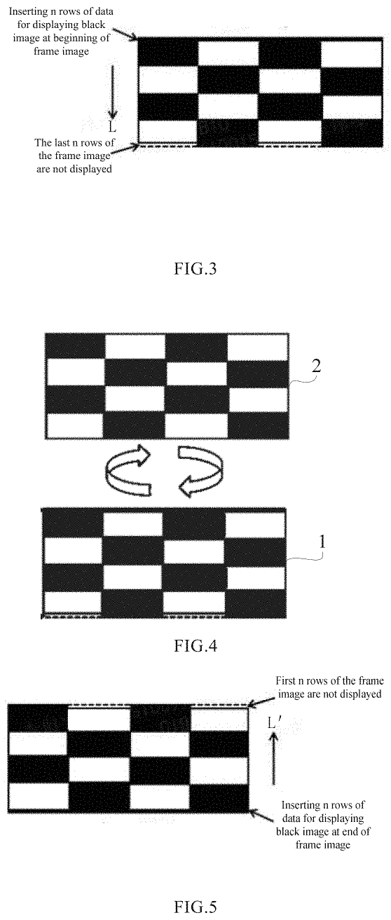

In order to solve the problem that the existing elimination method for the line afterimage cannot well eliminate the line afterimage for the large-sized or oversized screen, an embodiment of the present disclosure provides a display method, as shown in FIG. 2, which includes steps S1 to S4.

At step S1, a frame image at least including a local still image is detected, and a retention time of the still image in the frame image is accumulated, wherein the retention time refers to a time for continuously displaying the still image. For example, if the still image is uninterruptedly displayed for 30 minutes, the retention time is 30 minutes.

The still image is an entire or a portion of the frame image. At step S1, both of the dynamic image and the still image are detected, and the time accumulation is performed on the still image. The display of the frame image is controlled by a timing controller (TCON IC). The timing controller has a counter/timer therein. When the timing controller outputs information of the still image, the timer performs a time accumulation on the information of the still image. When the same data (e.g., the image with a large gray-scale difference and an obvious boundary, such as the gray scale 255 (L255) changes into the gray scale 0 (L0)) is uninterruptedly outputted for the entire of the image (i.e., the displayed still image) or the portion of the image (i.e., a TV logo statically displayed at a corner of a. dynamic video image when the dynamic video image is displayed), the timer starts to carry out the time accumulation, so as to obtain the accumulated retention time.

At step S2, whether the accumulated retention time of the still image is greater than a threshold value is determined.

If YES, that is, the accumulated retention time is greater than the threshold value, step S3 is executed. At step S3 the data of the frame image is sequentially shifted by n rows. The threshold value is the accumulated value of the retention time when the line afterimage begins to appear on the still image. A row direction of the n rows is a scanning direction of the frame image. 1≤n≤3N/4, where N is a total number of rows scanned in one frame image, n is an integer, and 3N/4 is rounded to an integer. In an embodiment, n ranges from 1 to 10.

The threshold value can be set according to the representations and applications of the line afterimages corresponding to various products. For example, after the 110 inch display screen B10 is optimized through the conventional method, the display screen substantially has no line afterimage when the display screen operates for less than 30 minutes; the line afterimage may disappear quickly in 1 or 2 seconds when the display screen operates for 1 hour; and the line afterimage may disappear within 10 minutes when the display screen operates for 168 hours. Therefore, the threshold value may be set to 30 minutes.

If NO at step S2, step S4 of continually accumulating the retention time of the still image is executed.

The display method can eliminate the line afterimage accumulated when the liquid crystal display panel displays the still image. The principle of eliminating the line afterimage is as follows. Since when the display gray scale changes dramatically (e.g., a black image suddenly changes to a white image), the DC component is easy to accumulate on the common electrode, so that the voltage of the common electrode is distorted due to the coupling effect and deviates from a predetermined value; and in the case where the deviation cannot be restored to the predetermined potential at the end of scanning of one row of pixels, the line afterimage will appear. By sequentially shifting the data of the frame image by n rows, the display gray scale at the position of the accumulated line afterimage is changes slightly (e.g., a black image changes to another black image or a gray image), so that the DC component accumulated on the common electrode is gradually released and eliminated, and in turn the accumulated line afterimage is eliminated. The display method can eliminate the line afterimage accumulated during the display of the still image, so that the line afterimage is substantially invisible to human eyes, namely the line afterimage is substantially invisible during the display process, thereby improving the display effect.

According to the display method, the retention time of the still image in the frame image is accumulated; and in the case that the accumulated retention time is larger than the threshold value, the data of the frame image is sequentially shifted by n rows, so that the DC component accumulated on the common electrode during the accumulated retention time (i.e., the threshold value) of the still image can be released, the DC component accumulated on the common electrode can be eliminated, thereby ensuring the pixel voltages of the positive and negative frames to be symmetrical with respect to the voltage of the common electrode, and eliminating the line afterimage formed by the DC component accumulated on the common electrode due to the fact that the pixel voltages are asymmetrical with respect the voltage of the common electrode.

Optionally, as shown in FIG. 3, the data of the frame image is sequentially shifted by n rows along a direction L in which the data of the frame image is input. When the frame image is displayed by a pixel array, in order to scan the pixel array row by row, a gate line extending along a row direction of the pixel array provides a scanning signal, so as to enable the pixels in the pixel array row by row. A data line extending along a column direction of the pixel array provides a data signal to the pixels in the pixel array to drive the pixels in the pixel array to display. The input direction L of data is an extending direction of the data line providing the data signal, that is, the column direction of the pixel array; and the scanning direction of the pixel array is an extending direction of the gate line, that is, the row direction of the pixel array.

Optionally, before the frame image is displayed, a rows of data for displaying a black image are inserted in the first n rows of the frame image, and the last n rows of the frame image are not displayed. Since the edge/edge frame of the still image (e.g., an advertisement column) is generally black, n rows of data for displaying a black image are inserted, so that the inserted data displays a black image and thus, may serve as the edge of the still image. The timing controller may insert n rows of data for displaying the black image (e.g., one, two, or more rows may be inserted, and the number of inserted rows can be adjusted according to the display effect) at the uppermost edge along a direction of generating the line afterimage. For n rows of inserted data for displaying the black image, the tail rows of the frame image are cut off and pushed into the black image to be not displayed. The shifting process mainly is performed for the direction of generating the line afterimage, and the position at which the DC component is easily accumulated enters a state for eliminating the line afterimage.

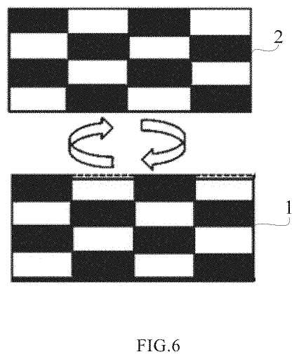

In the embodiment, as shown in FIG. 4, a frame image in which n rows of data for displaying the black image are inserted and n rows of data are sequentially shifted is an anti-afterimage frame image 1, and a frame image in which n rows of data for displaying the black image are not inserted and n rows of data are not sequentially shifted is an original frame image 2. The anti-afterimage frame image 1 and the original frame image 2 are alternately displayed. Therefore, the intermittent elimination of the accumulated afterimage can be realized, the line afterimage can be avoided when the still image is displayed, and the display effect of the still image can be ensured.

Optionally, a display time of the anti-afterimage frame image is the same as a display time of the original frame image, each of the display time of the anti-afterimage frame image and the display time of the original frame image is a time when the accumulated retention time of the still image reaches the threshold value. For example, after the 110 inch display screen B10 is optimized through the conventional method, the display screen substantially has no line afterimage when the display screen operates for less than 30 minutes, therefore both of the display time of the anti-afterimage frame image and the display time of the original frame image may be set to 30 minutes. As a result, the method can not only ensure the normal display of the frame image containing the still image, but also avoid the line afterimage of the still image during the display process, so as to ensure the display effect of the frame image containing the still image.

Optionally, the display time of the anti-afterimage frame image and the display time of the original frame image may also be different from each other. For example, the display time of the original frame image may be set to a time when the accumulated retention time of the still image reaches the threshold value; and the display time of the anti-afterimage frame image may be set to an elimination time of the line afterimage appearing when the accumulated retention time of the still image reaches the threshold value. The elimination time of the line afterimage is less than the time when the accumulated retention time of the still image reaches the threshold value. For example, after the 110 inch display screen B10 is optimized through the conventional method, the display screen substantially has no line afterimage when the display screen operates less than 30 minutes; the afterimage may quickly disappear in 1 or 2 seconds when the display screen operates for one hour. Therefore, the display time of the original frame image of the display screen may be set to 30 minutes, and the display time of the anti-afterimage frame image may be set to 2 seconds. As a result, the method can not only ensure the normal display of the frame image containing the still image, but also avoid the line afterimage of the still image during the display process, so as to ensure the display effect of the frame image containing the still image.

Optionally, the display method in the embodiment further includes: monitoring whether or not a person is watching the screen displaying the frame image. In response to nobody being watching the screen displaying the frame image, the switching between the anti-afterimage frame image and the original frame image is performed; and in response to a person being watching the screen displaying the frame image, the switching between the anti-afterimage frame image and the original frame image is not performed. That is, in the embodiment, when the accumulated retention time is greater than the threshold value, it can monitor whether someone is watching the screen with an equipment such as an infrared detection device or a human eye grasping device. In the case where nobody is watching the screen, the switching between the anti-afterimage frame image and the original frame image is performed; and in the case where someone is watching the screen, the switching between the anti-afterimage frame image and the original frame image is not performed. As a result, the user will not have a poor visual experience.

An embodiment of the present disclosure further provides a display method, which is different from the above-described embodiment in that, as shown in FIG. 5, the data of the frame image is sequentially shifted by n rows along a direction L′ opposite to the input direction of the data of the frame image. That is, in the embodiment, the first n rows of the frame image are not displayed, and the frame image is displayed directly starting from the (n+1)^{th} row.

In the embodiment, the n rows of data for displaying the black image are inserted after the display of the frame image is finished, and the first n rows of the frame image are not displayed. The n rows of data for displaying the black image are inserted at the end of the frame image and serve as the lower edge of the frame image.

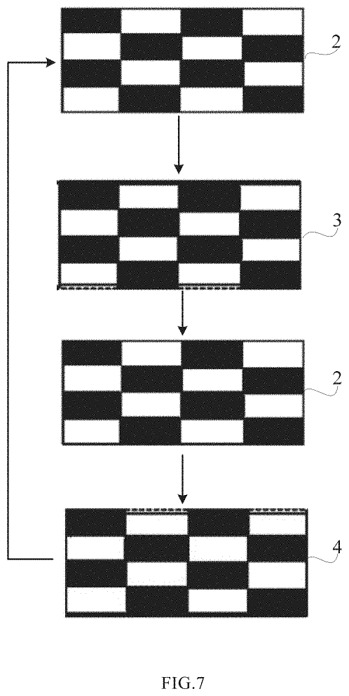

FIG. 6 is a schematic diagram showing that the afterimage frame image 1 and the original frame image 2 are alternately displayed in an embodiment.

Other steps of the display method in the embodiment are the same as those in the above embodiments, and will not be described herein again.

An embodiment of the present disclosure further provides a display method, which is different from the above embodiment in that, as shown in FIG. 7, before the frame image is displayed, a frame image in which the data for displaying the black image is inserted to the first n rows of the frame image and n rows of data are sequentially shifted is a first anti-afterimage frame image 3; after the frame image is displayed, a frame image in which the data for displaying the black image is inserted to the last n rows of the frame image and n rows of data are sequentially shifted is a second anti-afterimage frame image 4; and a frame image in which n rows of data for displaying the black image are not inserted and n rows of data are not sequentially shifted is an original frame image 2. The original frame image 2, the first anti-afterimage frame image 3, the original frame image 2, and the second anti-afterimage frame image 4 are alternately displayed in sequence.

Other steps of the display method in the embodiment are the same as those in the above embodiments, and will not be described herein again.

According to the display method provided by the embodiment of the present disclosure, the retention time of the still image in the frame image is accumulated; and the data of the frame image is sequentially moved or shifted by n rows in the case where the accumulated retention time is larger than the threshold value, so that the DC component accumulated on the common electrode during the accumulated retention time of the still image can be released and eliminated, thereby ensuring the pixel voltages of the positive and negative frames to be symmetrical with respect to the voltage of the common electrode, and eliminating the line afterimage formed by the DC component accumulated on the common electrode due to the fact that the pixel voltages are asymmetrical with respect to the voltage of the common electrode.

An embodiment of the present disclosure further provides a computer storage medium, where computer program instructions are stored in the computer storage medium, and when the computer program instructions are executed by a processor, the display method in any of the embodiments is implemented.

An embodiment of the present disclosure also provides a display device, which includes the computer storage medium in above embodiment.

With the computer storage medium in above embodiment, the display device can not generate line afterimages when the display device displays the still image, thereby ensuring the display effect of the display device.

The display device provided in the embodiment of the present disclosure may be any product or component having a display function, such as an LCD panel, an LCD television, a display, a mobile phone, and a navigator.

It should be understood that the above implementations are merely exemplary embodiments for the purpose of illustrating the principles of the present disclosure, however, the present disclosure is not limited thereto. It will be apparent to one of ordinary skill in the art that various changes and modifications can be made without departing from the spirit and essence of the present disclosure, which are also to be regarded as the scope of the present disclosure.

What is claimed is:

1. A display method, comprising:
detecting a frame image comprising a still image;
accumulating a retention time of the still image in the frame image, wherein the retention time is a time for uninterruptedly displaying the still image;
determining whether the accumulated retention time is greater than a threshold value; and
sequentially shifting data of the frame image by n rows in response to that the accumulated retention time is greater than the threshold value, wherein the threshold value is an accumulated value of the retention time when a line afterimage begins to appear on the still image, and a row direction of the n rows of data is a scanning direction of the frame image,
wherein 1≤n≤3N/4, N is a total number of rows scanned for one frame image, n is an integer, and 3N/4 is rounded to an integer.

2. The display method of claim 1, wherein data of the frame image is sequentially shifted by n rows along an input direction of the data of the frame image or a direction opposite to the input direction of the data of the frame image.

3. The display method of claim 2, further comprising: inserting n rows of data for displaying a black image into the frame image, wherein a frame image with the n rows of data for displaying the black image inserted and the n rows of data sequentially shifted is an anti-afterimage frame image, and a frame image without then rows of data for displaying the black image inserted and without the n rows of data sequentially shifted is an original frame image.

4. The display method of claim 3, further comprising:
inserting the n rows of data for displaying the black image into first n rows of the frame image, sequentially shifting the data of the frame image by n rows along the input direction of the data of the frame image, and displaying no data in last rows of the frame image, so as to obtain a first anti-afterimage frame image; and
alternately displaying the first anti-afterimage frame image and the original frame image.

5. The display method of claim 3, further comprises:
inserting the n rows of data for displaying the black image into last n rows of the frame image, sequentially shifting the data of the frame image by n rows along the direction opposite to the input direction of the data of the frame image, and displaying no data in first n rows of the frame image, so as to obtain a second anti-afterimage frame image; and
alternately displaying the second anti-afterimage frame image and the original frame image.

6. The display method of claim 3, further comprising:
inserting the n rows of data for displaying the black image into first n rows of the frame image, sequentially shifting the data of the frame image by n rows along the input direction of the data of the frame image, and displaying no data in last n rows of the frame image, so as to obtain a first anti-afterimage frame image;
inserting the n rows of data for displaying the black image into last n rows of the frame image, sequentially shifting the data of the frame image by n rows along the direction opposite to the input direction of the data of the frame image, and displaying no data in first n rows of the frame image, so as to obtain a second anti-afterimage frame image; and
sequentially displaying the original frame image, the first anti-afterimage frame image, the original frame image, and the second anti-afterimage frame image.

7. The display method of claim 3, wherein
each of a display time of the anti-afterimage frame image and a display time of the original frame image is equal to the threshold value.

8. The display method of claim 3, wherein
a display time of the original frame image is the threshold value,
a display time of the anti-afterimage frame image is an elimination time of the line afterimage appeared when the accumulated retention time of the still image reaches the threshold value, and
the elimination time of the line afterimage is less than the threshold value.

9. The display method of claim 3, further comprising: monitoring whether a person is watching a screen displaying the frame image; wherein
performing a switch between the anti-afterimage frame image and the original frame image in response to that nobody is watching the screen displaying the frame image, and
performing no switch between the anti-afterimage frame image and the original frame image in response to that a person is watching the screen displaying the frame image.

10. The display method of claim 9, wherein
monitoring whether a person is watching the screen displaying the frame image through an infrared detection device or an human eye grabbing device.

11. The display method of claim 1, wherein n is in a range from 1 to 10.

12. A computer storage medium having computer program instructions stored thereon, when executed by a processor, implement the display method of claim 1.

13. A display device comprising the computer storage medium of claim 12.
